(19) United States
(12) Patent Application Publication
(10) Pub. No.: US 2018/0277831 A1
(43) Pub. Date: Sep. 27, 2018

(54) NONAQUEOUS ELECTROLYTE SECONDARY BATTERY AND PRODUCTION METHOD THEREOF

(71) Applicant: Sanyo Electric Co., Ltd., Osaka (JP)

(72) Inventors: Shinichi Yamami, Hyogo (JP); Fumiya Kanetake, Hyogo (JP); Kentaro Takahashi, Hyogo (JP)

(73) Assignee: Sanyo Electric Co., Ltd., Osaka (JP)

(21) Appl. No.: 15/921,147

(22) Filed: Mar. 14, 2018

(30) Foreign Application Priority Data
Mar. 27, 2017 (JP) 2017-061064

(51) Int. Cl. H01M 4/133; H01M 4/1393; H01M 4/36; H01M 4/587; H01M 4/62; H01M 4/04; H01M 10/0525; H01M 10/0568

(52) U.S. Cl. CPC H01M 4/133; H01M 4/1393; H01M 4/366; H01M 4/587; H01M 2004/027; H01M 4/0404; H01M 10/0525; H01M 10/0568; H01M 4/625

(57) ABSTRACT

There is provided a nonaqueous electrolyte secondary battery in which lithium deposition on the surface of a negative electrode is suppressed. The nonaqueous electrolyte secondary battery includes a positive electrode, a negative electrode having a negative electrode active material mixture layer containing a negative electrode active material, and a nonaqueous electrolyte. The negative electrode active material contains coated graphite particles having surfaces coated with a coating layer which contains first amorphous carbon and second amorphous carbon. The negative electrode active material mixture layer contains the coated graphite particles and third amorphous carbon as a conductive agent. The nonaqueous electrolyte contains a difluorophosphate salt and a lithium salt having an oxalate complex as an anion.

### CROSS REFERENCE TO RELATED APPLICATIONS

The present invention application claims priority to Japanese Patent Application No. 2017-061064 filed in the Japan Patent Office on Mar. 27, 2017, the entire contents of which are incorporated herein by reference.

### BACKGROUND OF THE INVENTION

### Field of the Invention

The present invention relates to a nonaqueous electrolyte secondary battery and a production method thereof.

### Description of Related Art

Nonaqueous electrolyte secondary batteries such as a lithium ion secondary battery and the like are used as drive power supplies of mobile information terminals such as a cellular phone, a personal computer, and the like.

Also, nonaqueous electrolyte secondary batteries are used as drive power supplies of an electric vehicle (EV), a hybrid electric vehicle (HEV), and the like.

In addition, carbon materials with high crystallinity, such as natural graphite, artificial graphite, and the like, or amorphous carbon materials are used as negative electrode active materials of the nonaqueous electrolyte secondary batteries.

A technique proposed for suppressing a decrease in battery capacity after storage of a nonaqueous electrolyte secondary battery includes adding, to a nonaqueous electrolyte, a difluorophosphate salt such as lithium difluorophosphate or the like and a lithium salt having an oxalate complex as an anion, such as lithium bis(oxalato)borate or the like (Japanese Patent No. 5636622 (Patent Document 1)).

### BRIEF SUMMARY OF THE INVENTION

The inventors found the problem that when a difluorophosphate salt such as lithium difluorophosphate or the like and a lithium salt having an oxalate complex as an anion, such as lithium bis(oxalato)borate or the like, are added to a nonaqueous electrolyte, lithium is easily deposited on the surface of a negative electrode.

An object of the present invention is to suppress the deposition of lithium on the surface of a negative electrode in a nonaqueous electrolyte secondary battery in which a difluorophosphate salt such as lithium difluorophosphate or the like and a lithium salt having an oxalate complex as an anion, such as lithium bis(oxalato)borate or the like, are added to a nonaqueous electrolyte.

According to an aspect of the present invention, a nonaqueous electrolyte secondary battery includes a positive electrode, a negative electrode having a negative electrode active material mixture layer containing a negative electrode active material, and a nonaqueous electrolyte. The negative electrode active material contains coated graphite particles having surfaces coated with a coating layer which contains first amorphous carbon and second amorphous carbon. The negative electrode active material mixture layer contains the coated graphite particles and third amorphous carbon serving as a conductive agent, and the nonaqueous electrolyte contains a difluorophosphate salt and a lithium salt having an oxalate complex as an anion.

A nonaqueous electrolyte secondary battery according to an aspect of the present invention includes a nonaqueous electrolyte containing a difluorophosphate salt and a lithium salt having an oxalate complex as an anion, and thus a decrease in battery capacity after storage is suppressed.

The inventors found the problem that when a difluorophosphate salt and a lithium salt having an oxalate complex as an anion are added to a nonaqueous electrolyte, lithium is easily deposited on the surface of a negative electrode. As a result of research and examination of the cause thereof, it was found that lithium is deposited on the surface of a negative electrode for the following reason.

When a nonaqueous electrolyte contains a difluorophosphate salt and a lithium salt having an oxalate complex as an anion, a film derived from the difluorophosphate salt and the lithium salt having an oxalate complex as an anion is formed on the surface of a negative electrode active material due to charging or discharging. The film is considered to suppress a decrease in battery capacity after storage of a nonaqueous electrolyte secondary battery. However, the film causes an increase in resistance of a negative electrode. The increase in resistance of the negative electrode is considered to inhibit the smooth absorption of lithium ions into the negative electrode active material, and thus lithium is easily deposited on the surface of the negative electrode.

A nonaqueous electrolyte secondary battery according to an aspect of the present invention uses a negative electrode active material containing coated graphite particles having surfaces coated with a coating layer which contains first amorphous carbon and second amorphous carbon, and a negative electrode active material mixture layer contains third amorphous carbon as a conductive agent in addition to the coated graphite particles. In this configuration, an increase in resistance of the negative electrode can be effectively prevented, and the deposition of lithium on the surface of the negative electrode can be effectively suppressed.

The mass of the coating layer relative to the graphite particles in the coated graphite particles is preferably 0.5 wt % to 15 wt % and more preferably 1 wt % to 10 wt %.

The mass of the third amorphous carbon serving as the conductive agent relative to the coated graphite particles in the negative electrode active material mixture layer is preferably 0.5 wt % to 15 wt % and more preferably 1 wt % to 10 wt %.

The coating layer is preferably a layer composed of the first amorphous carbon and containing particles of the second amorphous carbon dispersed therein. The second amorphous carbon preferably has higher conductivity than the first amorphous carbon. The particles of the second amorphous carbon having high conductivity are dispersed in the coating layer, and thus electron conductivity in the coating layer is considered to be improved, thereby decreasing the resistance.

It is preferred that the first amorphous carbon is a pitch fired product, the second amorphous carbon is carbon black, and the third amorphous carbon is carbon black.

The difluorophosphate salt is preferably lithium difluorophosphate.

The lithium salt having an oxalate complex as an anion is preferably lithium bis(oxalato)borate.

According to an aspect of the present invention, a method for producing a nonaqueous electrolyte secondary battery including a positive electrode, a negative electrode having a negative electrode active material mixture layer containing a negative electrode active material, a nonaqueous electrolyte, and a battery case which houses the positive electrode, the negative electrode, and the nonaqueous electrolyte, includes a step of mixing coated graphite particles having surfaces coated with a coating layer, which contains first amorphous carbon and second amorphous carbon, third amorphous carbon serving as a conductive agent, a binder, and a dispersion medium to prepare a negative electrode active material mixture layer slurry, a step of applying the negative electrode active material mixture layer slurry on to a negative electrode core, a step of drying the negative electrode active material mixture layer slurry to form the negative electrode active material mixture layer, and a step of disposing the nonaqueous electrolyte containing a difluorophosphate salt and a lithium salt having an oxalate complex as an anion in the battery case.

The method can provide a nonaqueous electrolyte secondary battery in which a decrease in battery capacity after storage is suppressed, and the deposition of lithium on the surface of a negative electrode is suppressed.

According to the present invention, it is possible to provide a nonaqueous electrolyte secondary battery in which a decrease in battery capacity after storage is suppressed, and the deposition of lithium on the surface of a negative electrode is suppressed.

### BRIEF DESCRIPTION OF THE SEVERAL VIEWS OF THE DRAWINGS

FIG. 1 is a perspective view showing a prismatic secondary battery.

FIG. 2A is a sectional view taken along IIA-IIA inn FIG. 1.

FIG. 2B is a sectional view taken along IIB-IIB in FIG. 1.

FIG. 3 is a plan view of a positive electrode plate.

FIG. 4 is a plan view of a negative electrode plate.

### DETAILED DESCRIPTION OF THE INVENTION

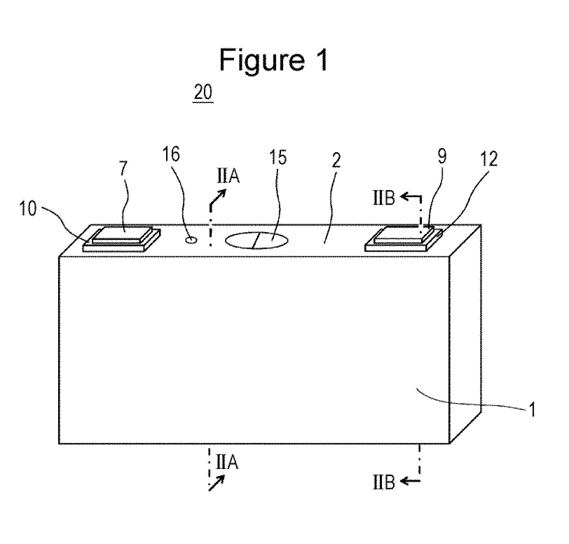

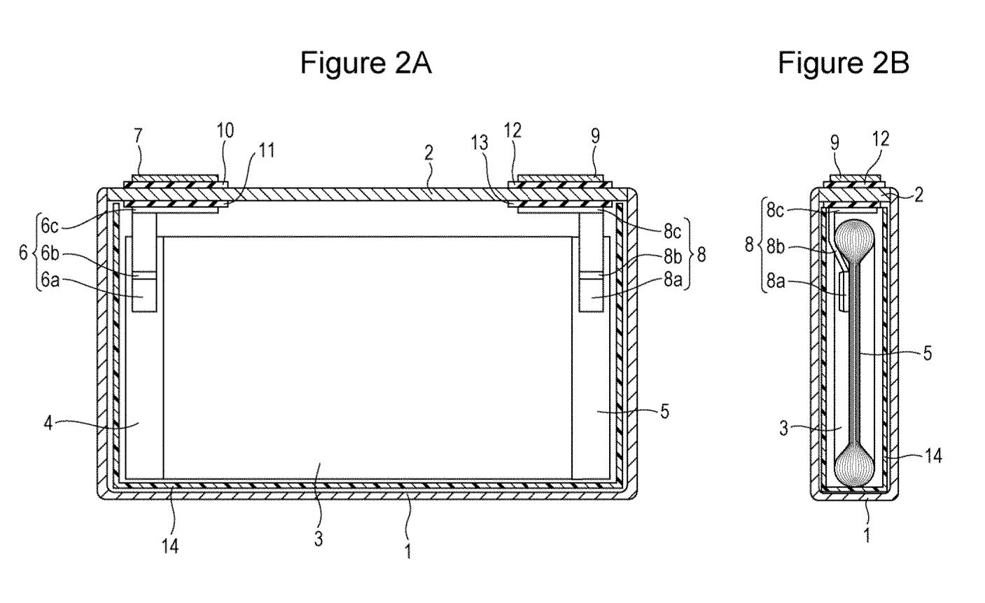

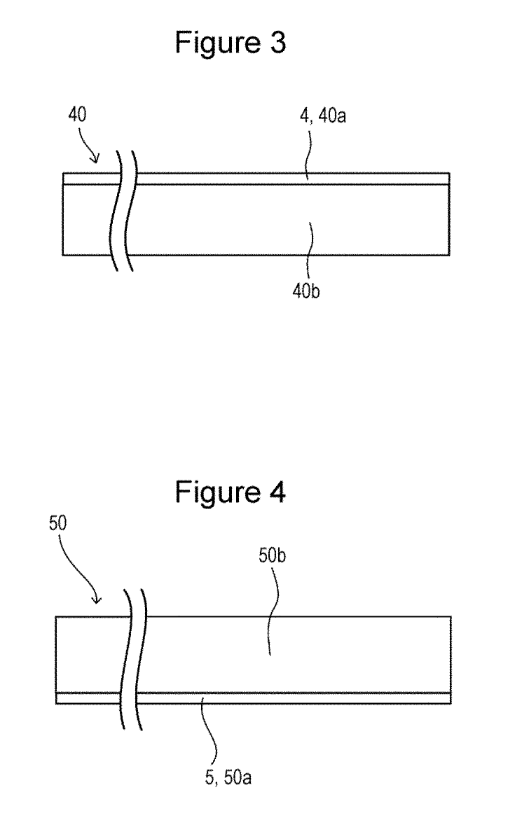

The structure and production method of a nonaqueous electrolyte secondary battery according to an embodiment of the present invention are described by using a prismatic secondary batter 20 as an example of a nonaqueous electrolyte secondary battery. FIG. 1 is a perspective view showing the prismatic secondary battery 20. FIG. 2A is a sectional view taken along IIA-IIA in FIG. 1. FIG. 2B is a sectional view taken along IIB-IIB in FIG. 1. FIG. 3 is a plan view of a positive electrode plate. FIG. 4 is a plan view of a negative electrode plate.

### [Formation of Positive Electrode Plate]

A slurry of a positive electrode active material mixture layer is prepared by kneading lithium-nickel-cobalt-manganese composite oxide (LiNi_{0.35}Co_{0.35}Mn_{0.30}O₂) used as a positive electrode active material, polyvinylidene fluoride used as a binder, carbon black used as a conducive agent, and N-methyl-2-pyrrolidone used as a dispersion medium. In this case, the mass ratio of lithium-nickel-cobalt-manganese composite oxide:polyvinylidene fluoride:carbon black is adjusted to be 91:3:6. Then, the slurry of a positive electrode active material mixture layer is applied to both surfaces of an aluminum foil (thickness of 15 μm) serving as a positive electrode core, and then N-methyl-2-pyrrolidone used as the dispersion medium is removed to form a positive electrode active material mixture layer on the positive electrode core. Then, the positive electrode active material mixture layer is rolled to a predetermined packing density (2.65 g/cm³) by using a rolling roller and cut into predetermined dimensions to form a positive electrode plate 40.

FIG. 3 is a plan view of the positive electrode plate 40. The positive electrode plate 40 has positive electrode active material mixture layers 40b formed on both surfaces of an elongated positive electrode core 40a. In addition, a positive electrode core exposed portion 4 is provided along the longitudinal direction of the positive electrode plate 40 at one of the ends in the width direction thereof.

### [Formation of Coated Graphite Particles as Negative Electrode Active Material]

### <Mixing>

Graphite particles composed of modified spherical natural graphite are mixed with carbon black to adhere carbon black to the surfaces of the graphite particles. Then, the graphite particles coated with carbon black are mixed with a pitch. In this case, a mixture is obtained by mixing the graphite particles, the pitch, and carbon black so that the mass ratio threrebetween is 88.4:4.7:6.9. In addition, the median particle diameter D50 of the graphite particles is 9 μm, the average particles size of carbon black is 90 nm, and the BET specific surface area is 45 m²/g.

### <Firing>

Next, the resultant mixture is fired in an inert gas atmosphere of 1250° C. for 24 hours, and the fired product is crushed/ground to produce coated graphite particles. The mass of the pitch is decreased by 30% due to carbonization by firing, but the masses of the graphite particles and the carbon black are substantially not decreased. Therefore, the mass ratio between the graphite particles, the fired product (carbonized product) of the pitch, and carbon black after firing is 89.7:3.3:7. In the coated graphite particles, carbon black particles are bonded to the peripheries of the graphite particles with the fired product (carbonized product) of the pitch. That is, the coated graphite particles have a state in which the surfaces of the graphite particles are coated with a coating layer composed of the fired product of the pitch, and the carbon black is dispersed in the coating layer. In addition, the median particle diameter D50 of the coated graphite particles is 9 μm, and the BET specific surface area of the coated graphite particles is 8.8 m²/g.

### [Formation of Negative Electrode Plate]

A slurry of a negative electrode active material mixture layer is prepared by kneading the coated graphite particles produced by the method described above, carbon black used as a conductive agent, carboxymethyl cellulose (CMC) used as a thickener, styrene-butadiene rubber (SBR) used as a binder, and water. In this case, the mass ratio between the coated graphite particles, carbon black, CMC, and SBR is adjusted to be 94.45:4.45:0.7:0.4. Then, the slurry of a negative electrode active material mixture layer is applied to both surfaces of a copper foil (thickness of 8 μm) serving as a negative electrode core, and then water is removed by drying to form a negative electrode active material mixture layer on the negative electrode core. Then, the negative electrode active material mixture layer is rolled to a predetermined packing density (1.1 g/cm³) by using a rolling roller and cut into predetermined dimensions to form a negative electrode plate 50.

FIG. 4 is a plan view of the negative electrode plate 50. The negative electrode plate 50 has negative electrode active material mixture layers 50b formed on both surfaces of an elongated negative electrode core 50a. In addition, a negative electrode core exposed portion 5 is provided along the longitudinal direction of the negative electrode plate 50 at one of the ends in the width direction thereof.

### [Formation of Wound Electrode Body]

The elongated positive electrode plate 40 and elongated negative electrode plate 50 formed by the method described above are wound through an elongated separator made of polyolefin and then pressed into a flat shape. The resultant flat-shaped wound electrode body 3 has a wound positive electrode core exposed portion 4 at one of the ends in the winding axis direction and a wound negative electrode core exposed portion 5 at the other end.

### [Preparation of Nonaqueous Electrolyte]

A mixed solvent is prepared by mixing ethylene carbonate (EC), ethylmethyl carbonate (EMC), and diethyl carbonate (DEC) at a volume ratio (25° C., 1 atom) of 25:35:40. Then, 1 mol/L of LiPF₆: 0.05 mol/L of lithium difluorophosphate (LiPF₂O₂), and 0.10 mol/L of lithiumn bis(oxalato)borate (LiBOB) are added to the mixed solvent. Further, vinylene carbonate is added so that the adding amount is 0.3% by mass relative to the total mass of a nonaqueous electrolyte, thereby preparing a nonaqueous electrolyte.

### [Mounting of Parts to Sealing Plate]

An external insulating member 10 is disposed on the battery outer surface side of the periphery of a positive electrode terminal mounting hole (not shown) provided in a sealing plate 2. In addition, an internal insulating member 11 and a base part 6c of a positive electrode current collector 6 are disposed on the battery inner surface side of the periphery of the positive electrode terminal mounting hole (not shown) provided in the sealing plate 2. A positive electrode terminal 7 is inserted from the outer side of the battery into a through hole of the external insulating member 10, the positive electrode terminal mounting hole, a through hole of the internal insulating member 11, and a through hole of the base part 6c of the positive electrode current collector 6, and the end of the positive electrode terminal 7 is caulked on the base part 6c of the positive electrode current collector 6. Consequently, the positive electrode terminal 7 and the positive electrode current collector 6 are fixed to the sealing plate 2. The caulked portion of the positive electrode terminal 7 is preferably welded to the base part 6c. The positive electrode current collector 6 has a connecting part 6a connected to the positive electrode core exposed portion 4, the base part 6c disposed between the sealing plate 2 and the wound electrode body 3, and a lead part 6b which connects the connecting part 6a to the base part 6c.

An external insulating member 12 is disposed on the battery outer surface side of the periphery of a negative electrode terminal mounting hole (not shown) provided in the sealing plate 2. In addition, an internal insulating member 13 and a base part 8c of a negative electrode current collector 8 are disposed on the battery inner surface side of the periphery of the negative electrode terminal mounting hole (not shown) provided in the sealing plate 2. A negative electrode terminal 9 is inserted from the outer side of the battery into a through hole of the external insulating member 12, the negative electrode terminal mounting hole, a through hole of the internal insulating member 13, and a through hole of the base part 8c of the negative electrode current collector 8, and the end of the negative electrode terminal 9 is caulked on the base part 8c of the negative electrode current collector 8. Consequently, the negative electrode terminal 9 and the negative electrode current collector 8 are fixed to the sealing plate 2. The caulked portion of the negative electrode terminal 9 is preferably welded to the base part 8c. The negative electrode current collector 8 has a connecting part 8a connected to the negative electrode core exposed portion 5, the base part 8c disposed between the sealing plate 2 and the wound electrode body 3, and a lead part 8b which connects the connecting part 8a to the base part 8c.

### [Mounting of Current Collector on Wound Electrode Body]

The connecting part 6a of the positive electrode current collector 6 is connected by welding to the wound positive electrode core exposed portion 4. The connecting part 8a of the negative electrode current collector 8 is connected by welding to the wound negative electrode core exposed portion 5. Welding connection can be performed by resistance welding, ultrasonic welding, welding with irradiation with energy rays such as laser or the like, or the like.

### [Assembly of Prismatic Secondary Battery]

The wound electrode body 3 on which the positive electrode current collector 6 and the negative electrode current collector 8 have been mounted is covered with a resin sheet 14 and inserted into a prismatic outer casing 1. Then, the sealing plate 2 is welded to the prismatic outer casing 1, and an opening of the prismatic outer casing 1 is sealed with the sealing plate 2. Then, a nonaqueous electrolyte is injected through an electrolyte injection hole provided in the sealing plate 2, and the electrolyte injection hole is sealed with a sealing plug 16. As a result, the prismatic secondary battery 20 is formed. In addition, the battery capacity is 5.5 Ah.

The flat-shaped wound electrode body 3 is disposed in the prismatic outer casing 1 in such a direction that the winding axis is parallel to the bottom of the prismatic outer casing 1. In this case, the electrically insulating resin sheet 14 is disposed between the prismatic outer casing 1 and the wound electrode body 3. Also, a gas exhaust valve 15 is provided in the sealing plate 2 so as to be broken to exhaust the gas in the prismatic outer casing 1 to the outside of the prismatic outer casing 1 when the pressure in the prismatic outer casing 1 becomes a predetermined value or more.

### Example 1

The prismatic secondary battery 20 formed by the method described above was used as a nonaqueous electrolyte secondary battery of Example 1.

### Example 2

A nonaqueous electrolyte secondary battery of Example 2 was formed by the same method as in Example 1 except that in the coated graphite particles after firing, the mass ratio between graphite particles, a fired product of pitch, and carbon black was 87.7:3.3:9, and the mass ratio between the coated graphite particles, carbon black used as a conductive agent, carboxymethyl cellulose used as a thickener, and styrene-butadiene rubber used as a binder was 93.46:5.44:0.7:0.4.

### Example 3

A nonaqueous electrolyte secondary battery of Example 3 was formed by the same method as in Example 1 except that in the coated graphite particles after firing, the mass ratio between graphite particles, a fired product of pitch, and carbon black was 91.7:3.3:5, and the mass ratio between the coated graphite particles, carbon black used as a conductive agent, carboxymethyl cellulose used as a thickener, and styrene-butadiene rubber used as a binder was 95.44:3.46:0.7:0.4.

### Example 4

A nonaqueous electrolyte secondary battery of Example 4 was formed by the same method as in Example 1 except that in the coated graphite particles after firing, two types of carbon black A and carbon black B having different physical properties were used as second amorphous carbon, and in the coated graphite particles after firing, the mass ratio between graphite particles, a fired product of pitch, carbon black A, and carbon black B was 89.7:3.3:3.5:3.5.

The carbon black A had an average particle size of 90 nm and a BET specific surface area of 45 m²/g. The carbon black B had an average particle size of 70 nm and a BET specific surface area of 60 m²/g.

### Comparative Example 1

A nonaqueous electrolyte secondary battery of Comparative Example 1 was formed by the same method as in Example 1 except that a coating layer of the coated graphite particles serving as the negative electrode active material did not contain carbon black, the negative electrode active material mixture layer did not contain carbon black as a conductive agent, and lithium difluorophosphate and lithium bis(oxalato)borate were not added to the nonaqueous electrolyte.

### Comparative Example 2

A nonaqueous electrolyte secondary battery of Comparative Example 2 was formed by the same method as in Example 1 except that a coating layer of the coated graphite particles serving as the negative electrode active material did not contain carbon black, and the negative electrode active material mixture layer did not contain carbon black as a conductive agent.

### Comparative Example 3

A nonaqueous electrolyte secondary battery of Comparative Example 3 was formed by the same method as in Example 1 except that lithium difluorophosphate and lithium bis(oxalato)borate were not added to the nonaqueous electrolyte.

### Comparative Example 4

A nonaqueous electrolyte secondary battery of Comparative Example 4 was formed by the same method as in Example 1 except that the negative electrode active material mixture layer did not contain carbon black as a conductive agent, and lithium difluorophosphate and lithium bis(oxalato)borate were not added to the nonaqueous electrolyte.

### Comparative Example 5

A nonaqueous electrolyte secondary battery of Comparative Example 5 was formed by the same method as in Example 1 except that a coating layer of the coated graphite particles serving as the negative electrode active material did not contain carbon black.

### Comparative Example 6

A nonaqueous electrolyte secondary battery of Comparative Example 6 was formed by the same method as in Example 1 except that flake-like graphite was used as a conductive agent in place of carbon black.

### <Evaluation of Storage Characteristics (Capacity Retention Rate)>

Each of the nonaqueous electrolyte secondary batteries of Examples 1 to 4 and Comparative Examples 1 to 6 was tested as follows.

The nonaqueous electrolyte secondary battery was charged at a constant current of 1 It until the voltage was 4.1 V, charged at a constant voltage of 4.1 V for 1.5 hours, and then discharged at a constant current of 1 It until the voltage was 2.5 V to determine a discharge capacity as a battery capacity before storage.

Next, the nonaqueous electrolyte secondary battery was charged under the condition of 25° C. until the state of charge (SOC) was 80%. The nonaqueous electrolyte secondary battery was stored at 70° C. for 56 days. Then, the nonaqueous electrolyte secondary battery was discharged to 2.5 V.

Next, the nonaqueous electrolyte secondary battery was charged at a constant current of 1 It until the voltage was 4.1 V, charged at a constant voltage of 4.1 V for 1.5 hours, and then discharged at a constant current of 1 It until the voltage was 2.5 V to determine a discharge capacity as a battery capacity after storage.

The capacity retention rate was calculated by the following formula.

Capacity retention rate=battery capacity after storage/battery capacity before storage

### <Evaluation of Low-Temperature Characteristics>

Each of the nonaqueous electrolyte secondary batteries of Examples 1 to 4 and Comparative Examples 1 to 6 was tested as follows.

The nonaqueous electrolyte secondary battery was charged under the condition of 25° C. until the state of charge (SOC) was 50%. Next, the nonaqueous electrolyte secondary battery was charged under the condition of −30° C. at a current of each of 1.6 It, 3.2 It, 4.8 It, 6.4 It, 8.0 It, and 9.6 It for 10 seconds to measure a battery voltage at each of the currents. The recovery during charging was determined by plotting the battery voltages versus current values.

### <Evaluation of Lithium Deposition Durability>

Each of the nonaqueous electrolyte secondary batteries of Examples 1 to 4 and Comparative Examples 1 to 6 was tested as follows.

The nonaqueous electrolyte secondary battery was charged under the condition of 25° C. until the state of charge (SOC) was 60%. Then, the nonaqueous electrolyte secondary battery was charged under the condition of 25° C. at a current of 31 It for 10 seconds, and discharged at 6 It for 50 seconds, and then paused for 300 seconds. This was regarded as 1 cycle and 1000 cycles were performed.

Then, the nonaqueous electrolyte secondary battery was disassembled, and the presence of lithium deposition on the surface of the negative electrode was confirmed by visual observation.

Table 1 shows the evaluation results of storage characteristics, low-temperature characteristics, and lithium deposition durability of the nonaqueous electrolyte secondary batteries of Examples 1 to 4 and Comparative Examples 1 to 6. The evaluation results of storage characteristics and low-temperature characteristics shown in Table 1 are shown by relative numerical values assuming that the evaluation results of Comparative Example 1 were 100. The presence of lithium deposition is shown as the evaluation result of lithium deposition durability.

TABLE 1

| | | | Amount of conductive | | | | | | |
|---|---|---|---|---|---|---|---|---|---|
| | Coating layer | | agent added (wt %) | | | | | | |
| | | Second amorphous | Third | | Content of | | Storage | | |
| | First amorphous | carbon (wt %) | amorphous | Flake- | electrolyte additive | | characteristics | Low- | Li |
| | carbon (pitch | *Carbon black | carbon (carbon | like | (mol/L) | | (capacity | temperature | deposition |
| | fired product) | A/B | black) | graphite | LiPF₂O₂ | LiBOB | retention rate) | characteristics | durability |
| Comparative | Yes | 0 | 0 | 0 | — | — | 100 | 100 | No |
| Example 1 | | | | | | | | | |
| Comparative | Yes | 0 | 0 | 0 | 0.05 | 0.1 | 117 | 84 | Yes |
| Example 2 | | | | | | | | | |
| Comparative | Yes | 7 | 4.45 | 0 | — | — | 97 | 104 | No |
| Example 3 | | | | | | | | | |
| Comparative | Yes | 7 | 0 | 0 | 0.05 | 0.1 | 110 | 90 | Yes |
| Example 4 | | | | | | | | | |
| Comparative | Yes | 0 | 4.45 | 0 | 0.05 | 0.1 | 110 | 95 | Yes |
| Example 5 | | | | | | | | | |
| Comparative | Yes | 7 | 0 | 4.5 | 0.05 | 0.1 | 110 | 89 | Yes |
| Example 6 | | | | | | | | | |
| Example 1 | Yes | 7 | 4.45 | 0 | 0.05 | 0.1 | 112 | 111 | No |
| Example 2 | Yes | 9 | 5.44 | 0 | 0.05 | 0.1 | 111 | 114 | No |
| Example 3 | Yes | 5 | 3.46 | 0 | 0.05 | 0.1 | 113 | 105 | No |
| Example 4 | Yes | *3.5/3.5 | 4.45 | 0 | 0.05 | 0.1 | 111 | 110 | No |

When as in Comparative Example 2, the nonaqueous electrolyte contains lithium difluorophosphate and lithium bis(oxalato)borate, the storage characteristics are improved as compared with Comparative Example 1. However, the low-temperature characteristics are degraded, and lithium deposition occurs. This is considered to be because a film derived from lithium difluorophosphate and lithium bis(oxalato)borate and formed on the surface of the negative electrode active material becomes a resistance component.

When as in Comparative Example 3, the coating layer of the coated graphite particles contains the pitch fired product and carbon black, and the negative electrode active material mixture layer contains the coated graphite particles and carbon black serving as a conductive agent, but the nonaqueous electrolyte does not contain lithium difluorophosphate and lithium bis(oxalato)borate, the storage characteristics are improved as compared with Comparative Example 1. This is considered to be because a film derived from lithium difluorophosphate and lithium bis(oxalato)borate is not formed on the surface of the negative electrode active material, and lithium is consumed by increased side reaction of the negative electrode active material with the nonaqueous electrolyte.

When as in Comparative Example 4, the nonaqueous electrolyte does not contain lithium difluorophosphate and lithium bis(oxalato)borate, and the coating layer of each of the coated graphite particles contains the pitch fired product and carbon black, but the negative electrode active material mixture layer does not contain carbon black as the conducive agent, the low-temperature characteristics are degraded, and lithium deposition occurs. This is considered to be because the negative electrode active material mixture layer does not contain carbon black as the conducive agent, and thus the electron conductivity of the negative electrode plate is unsatisfactory. Therefore, it is found that when the negative electrode active material mixture layer contains only the coated graphite particles each coated with a coating layer containing the first amorphous carbon and the second amorphous carbon, the effect of improving low-temperature characteristics and the effect of suppressing lithium deposition are unsatisfactory.

When as in Comparative Example 5, the nonaqueous electrolyte contains lithium difluorophosphate and lithium bis(oxalato)borate, and the negative electrode active material mixture layer contains carbon black as the conducive agent, but the coating layer of the coated graphite particles contains only the pitch fired product without containing carbon black, the low-temperature characteristics are degraded as compared with Comparative Example 1, and lithium deposition occurs. This is considered to be because the coating layer of each of the coated graphite particles does not contain carbon black, and thus the electron conductivity of the coating layer is unsatisfactory. Therefore, it is found that even when the negative electrode active material mixture layer contains carbon black as a conductive agent, the effect of improving low-temperature characteristics and the effect of suppressing lithium deposition are unsatisfactory.

It is found that when as in Comparative Example 6, the coating layer of the coated graphite particles contains the pitch fired product and carbon black, and the negative electrode active material mixture layer contains flake-like graphite, the effect of improving low-temperature characteristics and the effect of suppressing lithium deposition are unsatisfactory. This is considered to be because the flake-like graphite has lower electron conductivity than carbon black, and thus the electron conductivity of the negative electrode plate is unsatisfactory. Therefore, it is found that when the negative electrode active material mixture layer contains the flake-like graphite, the effect of improving low-temperature characteristics and the effect of suppressing lithium deposition are unsatisfactory.

In Examples 1 to 4, the nonaqueous electrolyte contains lithium difluorophosphate and lithium bis(oxalato)borate, the coating layer of each of the coated graphite particles contains the pitch fired product and carbon black, and the negative electrode active material mixture layer contains the coated graphite particles and carbon black as the conducive agent. Thus, the nonaqueous electrolyte secondary battery has excellent storage characteristics and low-temperature characteristics and no lithium deposition. In Example 1, the nonaqueous electrolyte contains lithium difluorophosphate and lithium bis(oxalato)borate, and the negative electrode active material mixture layer contains the coated graphite particles and carbon black as the conducive agent, and it is thus considered that an increase in resistance due to the film derived from lithium difluorophosphate and lithium bis(oxalato)borate can be effective suppressed, the low-temperature characteristics are improved, and lithium deposition is suppressed.

Also, in Example 1, the coating layer of the coated graphite particles contains the pitch fired product as the first amorphous carbon and carbon black as the second amorphous carbon. The carbon black (second amorphous carbon) has higher conductivity than that of the pitch fired product (first amorphous carbon), thereby more effectively improving electron conductivity in the negative electrode. Further, the carbon black (second amorphous carbon) is dispersed in the layer composed of the pitch fired product (first amorphous carbon), and thus the carbon black can be more effectively adhered to the surfaces of the graphite particles. It is thus found that the electron conductivity of the coating layer is improved, and thus the low-temperature characteristics and lithium deposition durability are improved. Also, the carbon black (second amorphous carbon) is strongly adhered to the graphite particles by the pitch fired product (first amorphous carbon).

The first amorphous carbon and the second amorphous carbon are different materials. However, the second amorphous carbon and the third amorphous carbon may be the same.

In the examples described above, description is made of an example in which carbon black (second amorphous carbon) was adhered to the surfaces of the graphite particles and then mixed with the pitch (material to be carbonized by firing and then used as the first amorphous carbon), followed by firing. Another method can be used, in which the material to be carbonized by firing and then used as the first amorphous carbon is mixed with the second amorphous carbon, and then the resultant mixture is adhered to the surfaces of the graphite particles and then fired.

### <Others>

Although, the present invention uses the pitch fired product as the first amorphous carbon, the fired product of a resin, heavy oil, or the like other than the pitch can be used.

Further, although carbon black is used as the second amorphous carbon, a conductive agent other than carbon black, such as acetylene black, Ketjen black, or the like can be used.

Further, although carbon black is used as the third amorphous carbon serving as a conductive agent, a conductive agent other than carbon black, such as acetylene black, Ketjen black, or the like can be used.

In the present invention, a counter cation of a difluorophosphate salt is preferably selected from the group consisting of lithium, sodium, potassium, magnesium, and calcium. In particular, lithium difluorophosphate is preferred. In addition, another compound may be coordinated to lithium difluorophosphate.

In the present invention, usable examples of a lithium salt having an oxalate complex as an anion include lithium bis(oxalato)borate, lithium difluoro(oxalato)borate salt, lithium tris(oxalato)phosphate salt, lithium difluoro(bisoxalato)phosphate salt, lithium tetrafluoro(oxalato)phosphate salt, and the like.

A known material used for nonaqueous secondary batteries can be used as a material of each of the positive electrode plate, the separator, the electrolyte, etc. Materials preferably used for the nonaqueous electrolyte secondary battery are as follows.

A lithium-transition metal composite oxide is preferably used as the positive electrode active material. Examples of the lithium-transition metal composite oxide include lithium cobaltate, lithium manganate, lithium nickelate, lithium-nickel-manganese composite oxide, lithium-nickel-cobalt composite oxide, lithium-nickel-cobalt-manganese composite oxide, and the like. In addition, the lithium-transition metal composite oxide to which Al, Ti, Zr, W, Nb, B, Mg, Mo, or the like is added can also be used. Also, Olivine-type iron-lithium phosphate can also be used.

The positive electrode active material mixture layer preferably contains the positive electrode active material, the binder, and the conductive agent. Polyvinylidene fluoride (PVdF) is particularly preferred as the binder, and a carbon material is particularly preferred as the conductive agent. In addition, an aluminum foil or aluminum alloy foil is preferred as the positive electrode core.

The packing density of the positive electrode active material mixture layer after rolling is preferably 2 g/cm³ or more and more preferably 2.5 g/cm³ or more.

Usable examples of a nonaqueous solvent (organic solvent) of the nonaqueous electrolyte include carbonates, lactones, ethers, ketones, esters, and the like. These solvents can be used as a mixture of two or more. An electrolyte salt of the nonaqueous electrolyte which is generally used as an electrolyte salt of usual lithium-ion secondary batteries can be used. In addition, a porous separator made of a polyolefin is preferably used as the separator.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A nonaqueous electrolyte secondary battery comprising:
a positive electrode;
a negative electrode having a negative electrode active material mixture layer containing a negative electrode active material; and
a nonaqueous electrolyte,
wherein the negative electrode active material contains coated graphite particles having surfaces coated with a coating layer which contains first amorphous carbon and second amorphous carbon;
the negative electrode active material mixture layer contains the coated graphite particles and third amorphous carbon as a conductive agent; and
the nonaqueous electrolyte contains a difluorophosphate salt and a lithium salt having an oxalate complex as an anion.

2. The nonaqueous electrolyte secondary battery according to claim 1, wherein the coating layer is a layer composed of the first amorphous carbon and containing particles of the second amorphous carbon dispersed therein.

3. The nonaqueous electrolyte secondary battery according to claim 1, wherein the second amorphous carbon has higher conductivity than the first amorphous carbon.

4. The nonaqueous electrolyte secondary battery according to claim 1,
wherein the first amorphous carbon is a pitch fired product;
the second amorphous carbon is carbon black; and
the third amorphous carbon is carbon black.

5. The nonaqueous electrolyte secondary battery according to claim 1, wherein the difluorophosphate salt is lithium difluorophosphate.

6. The nonaqueous electrolyte secondary battery according to claim 1, wherein the lithium salt having an oxalate complex as an anion is lithium bis(oxalato)borate.

7. A method for producing a nonaqueous electrolyte secondary battery including a positive electrode, a negative electrode having a negative electrode active material mixture layer containing a negative electrode active material, a nonaqueous electrolyte, and a battery case which houses the positive electrode, the negative electrode, and the nonaqueous electrolyte, the method comprising:
a step of mixing coated graphite particles having surfaces coated with a coating layer, which contains first amorphous carbon and second amorphous carbon, third amorphous carbon serving as a conductive agent, a binder, and a dispersion medium to prepare a negative electrode active material mixture layer slurry;
a step of applying the negative electrode active material mixture layer slurry on a negative electrode core;
a step of drying the negative electrode active material mixture layer slurry to form the negative electrode active material mixture layer; and
a step of disposing the nonaqueous electrolyte containing a difluorophosphate salt and a lithium salt having an oxalate complex as an anion in the battery case.

8. The method for producing a nonaqueous electrolyte secondary battery according to claim 7, wherein the coated graphite particles are produced by adhering a material to be carbonized by firing and used as the first amorphous carbon and the second amorphous carbon to the surfaces of graphite particles and then firing the graphite particles.

9. The method for producing a nonaqueous electrolyte secondary battery according to claim 7, wherein the coating layer is a layer composed of the first amorphous carbon and containing particles of the second amorphous carbon dispersed therein.

10. The method for producing a nonaqueous electrolyte secondary battery according to claim 7, wherein the second amorphous carbon has higher conductivity than the first amorphous carbon.

11. The method for producing a nonaqueous electrolyte secondary battery according to claim 7,
wherein the first amorphous carbon is a pitch fired product;
the second amorphous carbon is carbon black; and
the third amorphous carbon is carbon black.

12. The method for producing a nonaqueous electrolyte secondary battery according to claim 7, wherein the difluorophosphate salt is lithium difluorophosphate.

13. The method for producing a nonaqueous electrolyte secondary battery according to claim 7, wherein the lithium salt having an oxalate complex as an anion is lithium bis(oxalato)borate.
